(19) United States
(12) Patent Application Publication
(10) Pub. No.: US 2017/0111938 A1
(43) Pub. Date: Apr. 20, 2017

(54) METHOD, TERMINAL, CLIENT, SMARTCARD, AND SYSTEM FOR ACCESSING WIRELESS NETWORK

(71) Applicant: HUAWEI TECHNOLOGIES CO., LTD., Shenzhen, Guangdong (CN)

(72) Inventor: Xudong Gao, Nanjing (CN)

(73) Assignee: HUAWEI TECHNOLOGIES CO., LTD., Shenzhen, Guangdong (CN)

(21) Appl. No.: 14/903,259

(22) PCT Filed: Jun. 27, 2014
(86) PCT No.: PCT/CN2014/081003

§ 371 Date: Jan. 6, 2016

(51) Int. Cl. H04W 76/02; H04W 48/20; H04W 12/08

(52) U.S. Cl. CPC H04W 76/021; H04W 12/08; H04W 48/20; H04W 84/12

(57) ABSTRACT

The present invention provides a method for accessing a wireless network, where a terminal acquires an SSID (Service Set Identifier) and a password of the wireless network, controls a WIFI working mode of the terminal to be an AP (Access Point) mode, transmits an SSID signal of the terminal, detects a smartcard that accesses the terminal, and sends the SSID and password of the wireless network to the smartcard, so that the smartcard connects to the wireless network according to the received SSID and password of the wireless network and returns a connection result to the terminal. By using the method of the present invention, the smartcard can be managed according to a result of a connection success of the smartcard, and therefore, the management on the smartcard is quicker, more convenient, and more flexible, and manual input is avoided.

### CROSS REFERENCE TO RELATED APPLICATIONS

The present application claims priority under 35 U.S.C. §365 to International Patent Application No. PCT/CN2014/081003 filed Jun. 27, 2014 which is incorporated herein by reference into the present disclosure as if fully set forth herein.

### TECHNICAL FIELD

The present invention relates to the field of communications technologies, and in particular, to a method, terminal, client, smartcard, and system for accessing a wireless network.

### BACKGROUND

With the development of wireless network technologies, more and more smartcards implement access to a wireless network device. Currently, most of smartcards have their own WIFI module and a corresponding WIFI smartcard client. A working mode of the WIFI module has two types; one is an AP (Access Point) access point mode, where in this mode, the WIFI module provides a function of a WIFI access point and another device may access this access point. The other mode is a STA (Station) client mode, where in this mode, the WIFI module can connect to another WIFI access point. When the smartcard starts, the WIFI module in the smartcard automatically enters the AP mode and provides a fixed server set identifier SSID (Service Set Identifier), where the SSID is set when the smartcard is delivered from a factory. In an actual application, after a user starts, by using a mobile phone, a smartcard client corresponding to the smartcard, the mobile phone can connect to the smartcard by using the service set identifier SSID. After the user inputs an SSID and a password of a target router, the smartcard client sends the SSID and password of the target router to the smartcard. After receiving the SSID and password of the target router, the smartcard switches the WIFI working mode of the smartcard to the STA mode and connects to the target router according to the SSID and password of the target router. The smartcard client controls the mobile phone to access the target router by means of WIFI and search for, by using a link of the target router, the smartcard that accesses the wireless network. After the smartcard is found, the user can perform management on the smartcard. However, currently, in this technology, if the smartcard cannot be found, the management on the smartcard cannot be implemented, and there may be various reasons, for example, a reason may be that the smartcard cannot connect to the target router, or a connection of another aspect is faulty, and a true reason remains unknown.

### SUMMARY

In view of the foregoing raised technical problem in the prior art, embodiments of the present invention provide a method, terminal, client, smartcard, and system for accessing a wireless network, so as to implement a quicker, more convenient, and more flexible operation on the smartcard.

According to a first aspect, a method for accessing a wireless network is provided, including: acquiring, by a terminal, an SSID (Service Set Identifier) and a password of the wireless network; controlling a WIFI working mode of the terminal to be an AP (Access Point) mode, and transmitting an SSID signal of the terminal; and detecting a smartcard that accesses the terminal, and sending the SSID and password of the wireless network to the smartcard, so that the smartcard connects to the wireless network according to the received SSID and password of the wireless network and returns a connection result to the terminal.

With reference to the first aspect, in a first possible implementation manner of the first aspect, that the smartcard connects to the wireless network according to the received SSID and password of the wireless network and returns a connection result to the terminal includes: connecting, by the smartcard, to the wireless network; and if the connection succeeds, returning a connection result that includes a success code to the terminal.

With reference to the first possible implementation manner of the first aspect, the method further includes: if the connection result that is returned by the smartcard and received by the terminal is a connection success, controlling, according to the received result of the connection success, the terminal to switch to a STA (Station) working mode, enabling the terminal to connect to the wireless network and search for the smartcard that has already accessed the wireless network so as to perform control on the smartcard.

With reference to the first aspect or the first possible implementation manner of the first aspect, in a second possible implementation manner, that the smartcard connects to the wireless network according to the received SSID and password of the wireless network and returns a connection result to the terminal includes: if the connection fails, returning a connection result that includes an error code to the terminal, enabling the terminal to manage the smartcard according to the connection result that is returned by the smartcard.

With reference to the first aspect, the first possible implementation of the first aspect, and the second possible implementation manner of the first aspect, in a third possible implementation manner, the terminal installs a smartcard client corresponding to the smartcard to implement the method.

According to a second aspect, a method for accessing a wireless network is provided, including: controlling a WIFI working mode of a terminal to be an AP mode, and transmitting an SSID signal of the terminal, so that a smartcard searches for the SSID signal of the terminal and accesses the terminal; and detecting the smartcard that accesses the terminal, prompting a user to input an SSID and a password of the wireless network, and sending the SSID and password of the wireless network to the smartcard, where the smartcard connects to the wireless network according to the received SSID and password of the wireless network, and returns a connection result to the smartcard client.

With reference to the second aspect, in a first possible implementation manner of the second aspect, the method further includes: if the connection result that is returned by the smartcard and received by the terminal is a connection success, controlling, according to the received result of the connection success, the terminal to switch to a STA working mode, enabling the terminal to connect to the wireless network and search for the smartcard that has already accessed the wireless network so as to perform control on the smartcard.

With reference to the second aspect or the first possible implementation manner of the second aspect, in a second possible implementation manner, the method further includes: if a connection result that includes an error code and is returned by the smartcard and received by the terminal is a connection failure, connecting to an official website of the smartcard through a network, and querying information corresponding to the error code.

With reference to the second aspect, the first possible implementation of the second aspect, and the second possible implementation manner of the second aspect, in a third possible implementation manner, the method further includes: installing, by the terminal, a smartcard client corresponding to the smartcard to implement the method.

According to a third aspect, a terminal for accessing a wireless network is provided, including an acquiring unit, a WIFI control unit, a WIFI module, a detecting unit, and a smartcard interacting unit, where the acquiring unit is configured to acquire an SSID and a password of the wireless network; the WIFI control unit is configured to control a working mode of the WIFI module to be an AP working mode; the WIFI module is configured to transmit an SSID signal of the terminal in the AP working mode; the detecting unit is configured to detect a smartcard that accesses the terminal; and the smartcard interacting unit is configured to send the SSID and password of the wireless network to the smartcard that accesses the terminal, and receive a connection result that is of a connection to the wireless network and is returned by the smartcard.

With reference to the third aspect, in a first possible implementation manner, the WIFI control unit is further configured to, when the connection result of the connection to the wireless network is a success, control the WIFI module to switch to a STA working mode; the WIFI module is configured to switch to the STA working mode according to the WIFI control unit, and connect to the wireless network; the detecting unit is further configured to search for the smartcard that has already accessed the wireless network; and the smartcard interacting unit is further configured to control the smartcard.

With reference to the third aspect or the first possible implementation manner of the third aspect, in a second possible implementation manner, the terminal further includes a displaying unit, which is configured to, when the connection result of the connection to the wireless network is a failure, display prompt information of the connection failure and notify a user of the connection failure.

With reference to the second possible implementation manner of the third aspect, in a third possible implementation manner, the connection result of the connection to the wireless network includes an error code, and the terminal further includes a processing unit, which is configured to connect to an official website corresponding to the smartcard and query information corresponding to the error code.

According to a fourth aspect, a client for accessing a wireless network is provided, where the client is installed on a terminal and the client includes an acquiring unit, a WIFI control unit, a detecting unit, and a smartcard interacting unit, where the acquiring unit is configured to acquire an SSID and a password of the wireless network; the WIFI control unit is configured to control a WIFI working mode of the terminal to be an AP working mode, so that the terminal transmits an SSID signal; the detecting unit is configured to detect a smartcard that accesses the terminal; and the smartcard interacting unit is configured to send the SSID and password of the wireless network to the smartcard that accesses the terminal and receive a connection result that is of a connection to the wireless network and is returned by the smartcard.

With reference to the fourth aspect, in a first possible implementation manner, the acquiring unit includes a prompting subunit and a receiving subunit, where the prompting subunit is configured to prompt a user to input the SSID and password of the wireless network; and the receiving subunit is configured to receive the SSID and password of the wireless network that are input by the user.

With reference to the fourth aspect or the first possible implementation manner of the fourth aspect, in a second possible implementation manner, the WIFI control unit is further configured to, when the connection result of the connection to the wireless network is a success, control the terminal to switch to a STA working mode, enabling the terminal to connect to the wireless network; the detecting unit is further configured to search for the smartcard that has already accessed the wireless network; and the smartcard interacting unit is further configured to control the smartcard.

With reference to the fourth aspect, in a third possible implementation manner, the client further includes a displaying unit, which is configured to, when the connection result of the connection to the wireless network is a failure, display prompt information of the connection failure and notify a user of the connection failure; and the client further includes a processing unit, which is configured to connect to an official website corresponding to the smartcard and query information corresponding to an error code.

According to a fifth aspect, a system for accessing a wireless network is provided, where the system includes a terminal and a smartcard, and a smartcard client corresponding to the smartcard is installed on the terminal, where the smartcard client is configured to acquire an SSID and a password of the wireless network, control a WIFI working mode of the terminal to be an AP mode, and detect the smartcard that accesses the terminal; the terminal is configured to transmit an SSID signal of the terminal in the AP working mode; and the smartcard is configured to search for the SSID signal of the terminal and access the terminal, and is further configured to connect to the wireless network according to the received SSID and password of the wireless network that are sent by the smartcard client, and return a connection result to the smartcard client.

With reference to the fifth aspect, in a first possible implementation manner, the smartcard client is further configured to receive the connection result that is returned by the smartcard, and if the result is a connection success, control, according to the received result of the connection success, the terminal to switch to a STA working mode; the terminal is further configured to connect to the wireless network in the STA working mode; and the smartcard client is further configured to search for the smartcard that has already accessed the wireless network so as to perform control on the smartcard.

With reference to the fifth aspect or the first possible implementation manner of the fifth aspect, in a second possible implementation manner, the smartcard client is further configured to receive a connection result that includes an error code and is returned by the smartcard, connect to an official website of the smartcard through a network, and query information corresponding to the error code.

According to a sixth aspect, a smartcard for accessing a wireless network is provided, including a WIFI module, an accessing unit, and a client interacting unit, where the WIFI module is configured to search for an SSID signal of a terminal; the accessing unit is configured to access, according to the SSID signal of the terminal, a network provided by the terminal, and is further configured to access the wireless network according to an SSID and a password of the wireless network that are received by the client interacting unit; and the client interacting unit is configured to receive the SSID and password of the wireless network that are sent by the smartcard client, and is further configured to return a connection result of a connection to the wireless network to the smartcard client.

With reference to the sixth aspect, in a first possible implementation manner, the client interacting unit returns the connection result of the connection to the wireless network to the smartcard client is specifically as follows: returning a connection result that includes a success code to the smartcard client, or returning a connection result that includes an error code to the smartcard client.

In the foregoing solutions provided in the embodiments of the present invention, the terminal or the smartcard client acquires an SSID and a password of a wireless network and notifies the smartcard of the SSID and password of the wireless network, so that the smartcard connects to the wireless network; and in addition, the terminal or the smartcard client can manage the smartcard according a result of a connection success of the smartcard, so that management on the smartcard is quicker, more convenient and more flexible. In addition, in the embodiments of the present invention, the terminal or the smartcard client can further prompt a user about a connection situation according to a connection result that is returned by the smartcard, so as to improve user experience.

### BRIEF DESCRIPTION OF THE DRAWINGS

FIG. 1 is a schematic structural diagram of a system for accessing a wireless network by a smartcard according to an embodiment of the present invention;

FIG. 2 is a flowchart of a method for accessing a wireless network according to an embodiment of the present invention;

FIG. 3 is a flowchart of a method for accessing a wireless network according to an embodiment of the present invention;

FIG. 4 is a flowchart of a method for accessing a wireless network according to an embodiment of the present invention;

FIG. 5 is a flowchart of a method for accessing a wireless network according to an embodiment of the present invention;

FIG. 6 is a schematic structural diagram of a terminal for accessing a wireless network according to an embodiment of the present invention;

FIG. 7 is a schematic structural diagram of a client for accessing a wireless network according to an embodiment of the present invention;

FIG. 8 is a schematic structural diagram of a smartcard for accessing a wireless network according to an embodiment of the present invention;

FIG. 9 is a schematic structural diagram of a terminal for accessing a wireless network according to an embodiment of the present invention;

FIG. 10 is a schematic structural diagram of a smartcard for accessing a wireless network according to an embodiment of the present invention; and

FIG. 11 is a schematic structural diagram of a system for accessing a wireless network according to an embodiment of the present invention.

### DETAILED DESCRIPTION

In order to solve a technical problem currently exists in a process of accessing a wireless network by a smartcard, in the present invention, a smartcard is controlled to access a wireless network by prompting an access result in a process of accessing a target router by the smartcard and according to a difference of the access result.

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

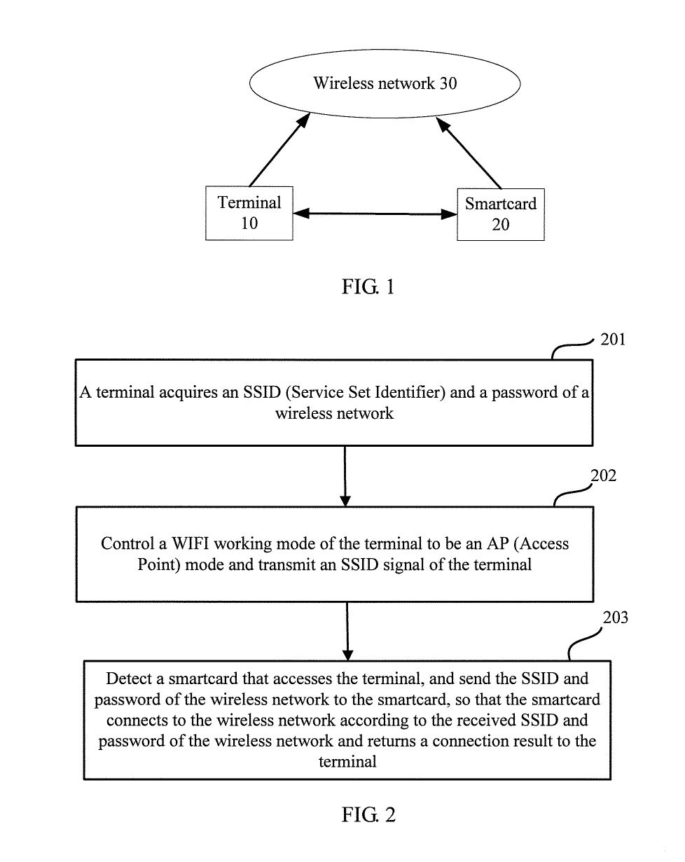

Referring to FIG. 1, which is a schematic diagram of a system for accessing a wireless network by a smartcard according to an embodiment of the present invention, the system for accessing a wireless network includes a terminal 10, a smartcard 20, and a wireless network 30. The smartcard in this embodiment of the present invention may be an access device that is easy to carry, such as an SD (Smart Card), or may be a wearable device. The terminal may be a terminal that can connect to a wireless network, such as a mobile phone and a PAD. After the smartcard is started, a WIFI module in the smartcard runs in a STA working mode and searches for a service set identifier SSID of the terminal. A smartcard client of the smartcard may be pre-installed on the terminal. After the terminal starts the smartcard client, network access information of a wireless network that is currently used by the terminal is acquired, such as, an SSID and a password of the wireless network. The smartcard client may further prompt a user to input an SSID and a password of a wireless network, so that the user may select a wireless network that needs to be accessed. The smartcard client may control a WIFI module of the terminal to enter an AP working mode, provide a function of a network access point, and provide a signal of the service set identifier SSID of the terminal, so that the smartcard can access the terminal. The smartcard searches for the SSID provided by the terminal and accesses a network provided by the terminal. The smartcard client detects the smartcard that accesses the terminal and sends the SSID and password of the wireless network to the smartcard that accesses the terminal. The smartcard connects to the wireless network according to the received SSID and password of the wireless network and notifies the smartcard client of a connection result of the connection to the wireless network. The smartcard client may be notified of the connection result in a manner of a success code or an error code. If the smartcard client receives the success code, the terminal is controlled, according to the received connection result, to switch to a STA working mode; then the terminal connects to the wireless network, and the smartcard client searches for the smartcard that has already accessed the wireless network, and implements management on the smartcard. When the smartcard client receives the error code, that is, when the connection result of the connection to the wireless network is a failure, prompt information of the connection failure can be displayed and the user is notified of the connection failure. The smartcard client may further connect to an official website of the smartcard and query a solution corresponding to the error code, so that a fault of connecting to a wireless network by the smartcard is solved in time, and timeliness of connecting to the wireless network by the smartcard is ensured.

The system provided in this embodiment of the present invention acquires an SSID and a password of a wireless network and notifies the smartcard of the SSID and password of the wireless network, so that the smartcard connects to the wireless network; and in addition, the system can manage the smartcard according to a result of a connection success of the smartcard, so that the management on the smartcard is quicker, more convenient, and more flexible. In addition, in this embodiment of the present invention, the system can further prompt a user about a connection situation according to a connection result that is returned by the smartcard, so as to improve user experience.

As shown in FIG. 2, an embodiment of the present invention provides a method for accessing a wireless network, and the method includes:

S201: A terminal acquires an SSID (Service Set Identifier) and a password of the wireless network.

S202: Control a WIFI working mode of the terminal to be an AP (Access Point) mode and transmit an SSID signal of the terminal.

S203: Detect a smartcard that accesses the terminal and send the SSID and password of the wireless network to the smartcard, so that the smartcard connects to the wireless network according to the received SSID and password of the wireless network and returns a connection result to the terminal.

In this embodiment of the present invention, that the smartcard connects to the wireless network according to the received SSID and password of the wireless network and returns a connection result to the terminal includes: connecting, by the smartcard, to the wireless network; and if the connection succeeds, returning a connection result that includes a success code to the terminal.

In this embodiment of the present invention, the method further includes: if the connection result that is returned by the smartcard and received by the terminal is a connection success, controlling, according to the received result of the connection success, the terminal to switch to a STA (Station) working mode, enabling the terminal to connect to the wireless network and search for the smartcard that has already accessed the wireless network so as to perform control on the smartcard.

In this embodiment of the present invention, that the smartcard connects to the wireless network according to the received SSID and password of the wireless network and returns a connection result to the terminal includes: if the connection fails, returning a connection result that includes an error code to the terminal, enabling the terminal to manage the smartcard according to the connection result that is returned by the smartcard.

In this embodiment of the present invention, the foregoing method may be implemented by installing, on the terminal, a smartcard client corresponding to the smartcard, where the smartcard client may be configured to perform steps of the foregoing method.

According to the method provided in this embodiment of the present invention, the smartcard client acquires an SSID and a password of a wireless network that is currently accessed by a terminal, and notifies the smartcard of the SSID and password of the wireless network, so that the smartcard connects to the wireless network; and in addition, the smartcard client can manage the smartcard according to a result of a connection success of the smartcard, so that the management on the smartcard is quicker, more convenient, and more flexible, and manual input is avoided. In addition, in this embodiment of the present invention, the smartcard client can further prompt a user about a connection situation according to a connection result that is returned by the smartcard, so as to improve user experience.

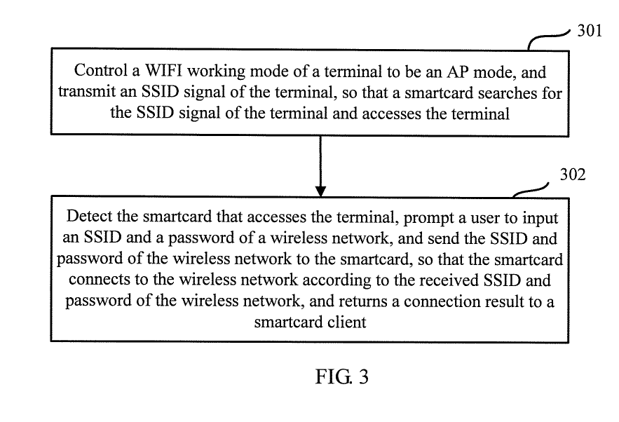

As shown in FIG. 3, an embodiment of the present invention provides a method for accessing a wireless network, and the method includes:

S301: Control a WIFI working mode of a terminal to be an AP mode, and transmit an SSID signal of the terminal, so that a smartcard searches for the SSID signal of the terminal and accesses the terminal.

S302: Detect the smartcard that accesses the terminal, prompt a user to input an SSID and a password of a wireless network, and send the SSID and password of the wireless network to the smartcard, so that the smartcard connects to the wireless network according to the received SSID and password of the wireless network, and returns a connection result to the smartcard client.

In this embodiment of the present invention, the method further includes: if the connection result that is returned by the smartcard and received by the terminal is a connection success, controlling, according to the received result of the connection success, the terminal to switch to a STA working mode, enabling the terminal to connect to the wireless network and search for the smartcard that has already accessed the wireless network so as to perform control on the smartcard.

In this embodiment of the present invention, the method further includes: if the connection result that includes an error code and is returned by the smartcard and received by the terminal is a connection failure, connecting to an official website of the smartcard through a network, and querying information corresponding to the error code.

In this embodiment of the present invention, the foregoing method may be implemented by installing, on the terminal, the smartcard client corresponding to the smartcard, where the smartcard client may be configured to perform steps of the foregoing method.

According to the method provided in this embodiment of the present invention, the smartcard client acquires an SSID and a password of a wireless network that is currently accessed by a terminal, and notifies the smartcard of the SSID and password of the wireless network, so that the smartcard connects to the wireless network; and in addition, the smartcard client can manage the smartcard according to a result of a connection success of the smartcard, so that the management on the smartcard is quicker, more convenient, and more flexible, and manual input is avoided. In addition, in this embodiment of the present invention, the smartcard client can further prompt a user about a connection situation according to a connection result that is returned by the smartcard, so as to improve user experience.

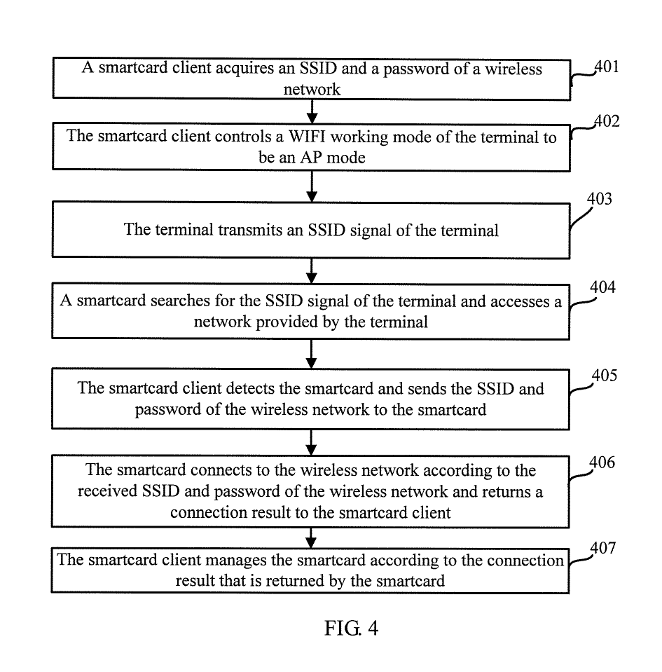

Referring to FIG. 4, an embodiment of the present invention provides a method for accessing a wireless network, where the method is described by using an example in which a smartcard accesses a wireless network, and the method may be applied to a system that includes a smartcard, a smartcard client, and a wireless network. In this embodiment of the present invention, the smartcard client is installed in a terminal that accesses the wireless network, and the method includes the following steps:

S401: The smartcard client acquires an SSID and a password of the wireless network.

In this embodiment of the present invention, the terminal currently accesses the wireless network, the terminal starts the smartcard client, and the smartcard client may acquire the SSID and password of the wireless network by using the terminal.

S402: The smartcard client controls a WIFI working mode of the terminal to be an AP mode.

The smartcard client enables a working mode of a WIFI module of the terminal to be the AP mode by invoking an interface, so that the smartcard can access a network provided by the terminal.

S403: The terminal transmits an SSID signal of the terminal.

S404: The smartcard searches for the SSID signal of the terminal and accesses a network provided by the terminal.

S405: The smartcard client detects the smartcard and sends the SSID and password of the wireless network to the smartcard.

S406: The smartcard connects to the wireless network according to the received SSID and password of the wireless network and returns a connection result to the smartcard client.

In this embodiment of the present invention, the smartcard connects to the wireless network, where if the connection succeeds, a connection result that includes a success code is returned to the smartcard client; and if the connection fails, a connection result that includes an error code may be returned to the smartcard client.

In this embodiment of the present invention, the method for accessing a wireless network may further include:

S407: The smartcard client manages the smartcard according to the connection result that is returned by the smartcard.

If the smartcard client receives the success code, the terminal is controlled, according to the received result of the connection success, to switch to a STA working mode; then the terminal connects to the wireless network; and the smartcard client searches for the smartcard that has already accessed the wireless network, and implements management on the smartcard.

If the smartcard client receives the error code, prompt information of the error may be displayed and a user may be notified of a connection failure.

In another embodiment of the present invention, when receiving the error code, the smartcard client may further connect to an official website of the smartcard through a network and query a solution corresponding to the error code, so that a fault of connecting to a wireless network by the smartcard is solved in time and timeliness of connecting to the wireless network by the smartcard is ensured.

In this embodiment of the present invention, the smartcard client acquires an SSID and a password of a wireless network that is currently accessed by a terminal, and notifies the smartcard of the SSID and password of the wireless network, so that the smartcard connects to the wireless network; and in addition, the smartcard client can manage the smartcard according to a result of a connection success of the smartcard, so that the management on the smartcard is quicker, more convenient, and more flexible, and manual input is avoided. In addition, in this embodiment of the present invention, the smartcard client can further prompt a user about a connection situation according to a connection result that is returned by the smartcard, so as to improve user experience.

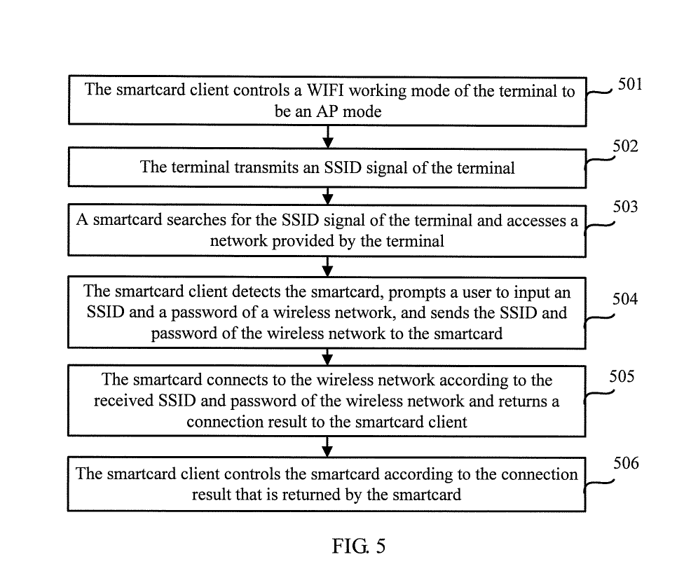

FIG. 5 provides another method for accessing a wireless network according to an embodiment of the present invention. In this embodiment, a smartcard is used as an example for description. The method may be applied to a system that includes a smartcard, a smartcard client, and a wireless network. In this embodiment of the present invention, the smartcard client is installed in a terminal, and the method includes the following steps:

S501: The smartcard client controls a WIFI working mode of the terminal to be an AP mode.

After the smartcard client is started on the terminal, the smartcard client enables the WIFI working mode of the terminal to be the AP mode by invoking an interface; and the terminal transmits an SSID signal of the terminal, so that the smartcard can access a network provided by the terminal.

S502: The terminal transmits an SSID signal of the terminal.

S503: The smartcard searches for the SSID signal of the terminal and accesses a network provided by the terminal.

S504: The smartcard client detects the smartcard, prompts a user to input an SSID and a password of the wireless network, and sends the SSID and password of the wireless network to the smartcard.

S505: The smartcard connects to the wireless network according to the received SSID and password of the wireless network and returns a connection result to the smartcard client.

In this embodiment of the present invention, the smartcard connects to the wireless network, where if the connection succeeds, a connection result that includes a success code is returned to the smartcard client; and if the connection fails, a connection result that includes an error code may be returned to the smartcard client.

In this embodiment of the present invention, the method for accessing a wireless network may further include:

S506: The smartcard client controls the smartcard according to the connection result that is returned by the smartcard.

If the smartcard client receives the success code, the terminal is controlled, according to the received result of the connection success, to switch to a STA working mode; then the terminal connects to the wireless network; and the smartcard client searches for the smartcard that has already accessed the wireless network so as to perform control on the smartcard and implement management on the smartcard.

If the smartcard client receives the error code, prompt information of the error may be displayed and a user may be notified of a connection failure.

In another embodiment of the present invention, when receiving the error code, the smartcard client may further connect to an official website of the smartcard through a network and query information corresponding to the error code, so that a solution is acquired according to the information corresponding to the error code, a fault of connecting to a wireless network by the smartcard is solved in time, and timeliness of connecting to the wireless network by the smartcard is ensured.

In this embodiment of the present invention, the smartcard client prompts a user to input an SSID and a password of a wireless network, so that access to the wireless network is quicker and easier and a user conveniently selects a wireless network that needs to be accessed; the smartcard client notifies the smartcard of the SSID and password of the wireless network, so that the smartcard connects to the wireless network; in addition, the smartcard client can manage the smartcard according to a result of a connection success of the smartcard, so that the management on the smartcard is quicker, more convenient, and more flexible. In addition, in this embodiment of the present invention, the smartcard client can further prompt a user about a connection situation according to a connection result that is returned by the smartcard, so as to improve user experience.

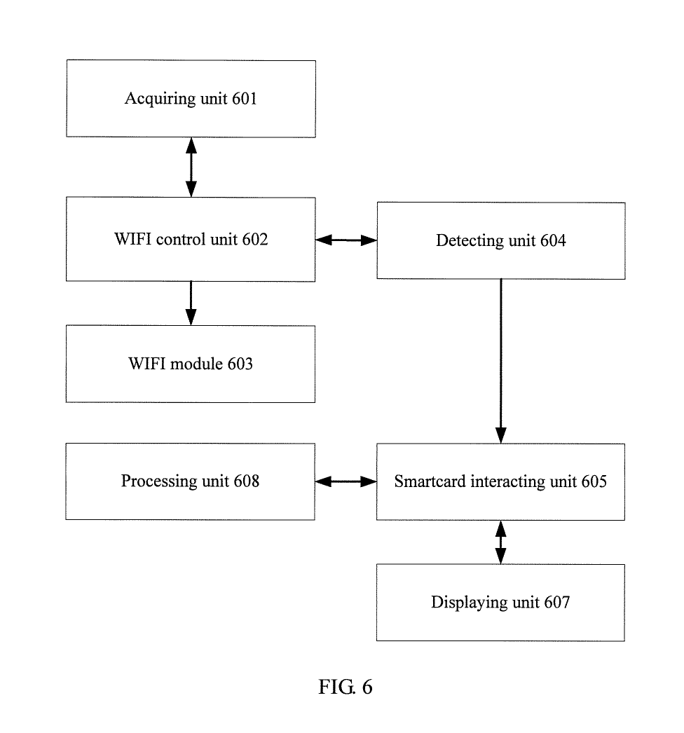

FIG. 6 is a schematic structural diagram of a terminal for accessing a wireless network according to an embodiment of the present invention, where the terminal includes an acquiring unit 601, a WIFI control unit 602, a WIFI module 603, a detecting unit 604, and a smartcard interacting unit 605.

The acquiring unit 601 is configured to acquire an SSID and a password of the wireless network.

In this embodiment of the present invention, the acquiring unit 601 may acquire the SSID and password of the wireless network in multiple manners.

For example, if the terminal currently accesses a wireless network, the acquiring unit 601 may acquire an SSID and a password of the wireless network that is currently accessed by the terminal. The acquiring unit 601 may further acquire the SSID and password of the wireless network by prompting a user to input the SSID and password of the wireless network.

In this embodiment of the present invention, the acquiring unit 601 may further include a prompting subunit 6011 and a receiving subunit 6012, where the prompting subunit 6011 is configured to prompt the user to input the SSID and password of the wireless network, and the receiving subunit 6012 is configured to receive the SSID and password of the wireless network that are input by the user.

The WIFI control unit 602 is configured to control switching of a working mode of the WIFI module 603 of the terminal. For example, the working mode is switched from a STA working mode to an AP working mode, or switched from an AP working mode to a STA working mode.

The WIFI module 603 is configured to transmit an SSID signal of the terminal.

The WIFI module 603 is configured to switch between the AP working mode and the STA working mode, where in the AP working mode, the SSID signal is transmitted; and in the STA working mode, the wireless network is accessed.

The detecting unit 604 is configured to detect a smartcard that accesses the terminal.

The smartcard interacting unit 605 is configured to send the SSID and password of the wireless network to the smartcard that accesses the terminal, and receive a connection result that is of a connection to the wireless network and is returned by the smartcard.

In another embodiment of the present invention, the WIFI control unit 602 is further configured to, when the connection result of the connection to the wireless network is a success, control the WIFI module 603 to switch to the STA working mode;

the WIFI module 603 is configured to switch to the STA working mode according to the WIFI control unit 602, and connect to the wireless network;

the detecting unit 604 is further configured to search for the smartcard that has already accessed the wireless network; and

the smartcard interacting unit 605 is further configured to manage the smartcard.

The terminal further includes a displaying unit 607, where the displaying unit 607 is configured to, when the connection result of the connection to the wireless network is a failure, display prompt information of the connection failure and notify a user of the connection failure.

The terminal further includes a processing unit 608, which is configured to connect to an official website corresponding to the smartcard, query information corresponding to an error code, and acquire a solution according to the information corresponding to the error code, so that a fault of connecting to the wireless network by the smartcard is solved in time, and timeliness of connecting to the wireless network by the smartcard is ensured.

In another embodiment of the present invention, the terminal further includes a processing unit 607 and a displaying unit 608. The processing unit 607 is configured to, when the connection result of the connection to the wireless network is a failure, instruct the displaying unit 608 to display prompt information of the connection failure and notify a user of the connection failure, and the displaying unit 608 is configured to display the prompt infatuation of the connection failure.

The processing unit 607 is further configured to connect to an official website corresponding to the smartcard and query a solution corresponding to an error code, so that a fault of connecting to the wireless network by the smartcard is solved in time, and timeliness of connecting to the wireless network by the smartcard is ensured.

In this embodiment of the present invention, the processing unit may be set to perform subsequent processing when the connection result of the connection to the wireless network is a success, or may be set to perform subsequent processing when the connection result of the connection to the wireless network is a failure, or set to always perform subsequent processing when the connection result of the connection to the wireless network is a success or a failure.

The terminal provided in this embodiment of the present invention acquires an SSID and a password of a wireless network and notifies the smartcard of the SSID and password of the wireless network, so that the smartcard connects to the wireless network; and in addition, the terminal can manage the smartcard according to a result of a connection success of the smartcard, so that the management on the smartcard is quicker, more convenient and more flexible. In addition, in this embodiment of the present invention, the terminal can further prompt a user about a connection situation according to a connection result that is returned by the smartcard, so as to improve user experience.

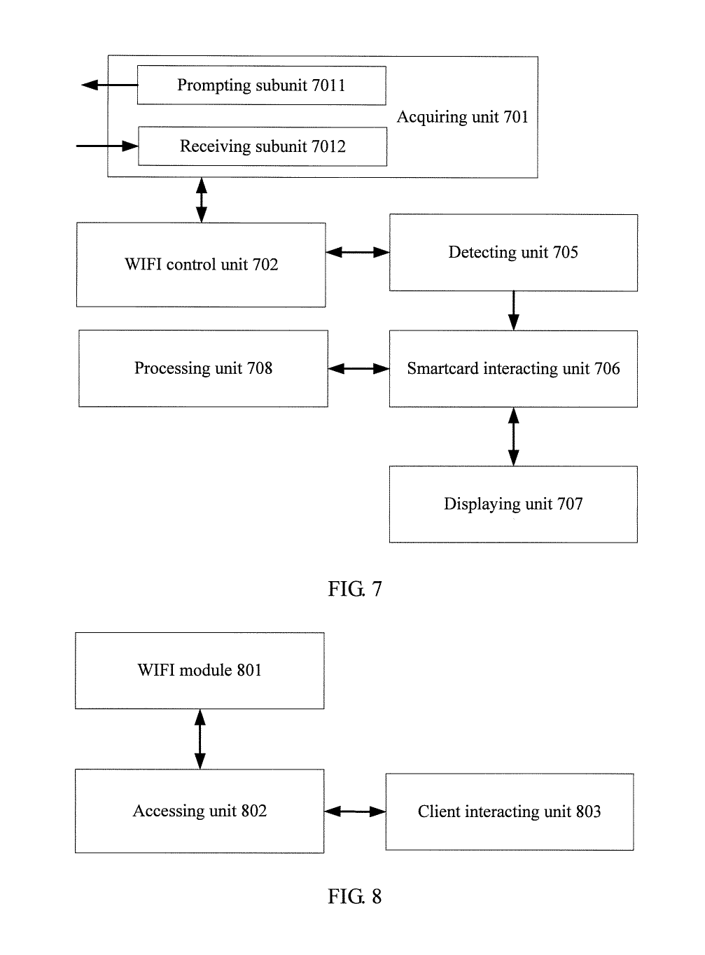

FIG. 7 is a schematic structural diagram of a client for accessing a wireless network according to an embodiment of the present invention, where the client 70 may be installed on a terminal 10, where the terminal includes a WIFI module 703, and the client 70 performs management on a smartcard by using the terminal. The client 70 includes an acquiring unit 701, a WIFI control unit 702, a detecting unit 705, and a smartcard interacting unit 706.

The acquiring unit 701 is configured to acquire an SSID and a password of the wireless network.

In this embodiment of the present invention, the acquiring unit 701 may acquire the SSID and password of the wireless network in multiple manners.

For example, if the terminal currently accesses a wireless network, the acquiring unit 701 may acquire an SSID and a password of the wireless network that is currently accessed by the terminal. The acquiring unit 701 may further acquire the SSID and password of the wireless network by prompting a user to input the SSID and password of the wireless network.

In this embodiment of the present invention, the acquiring unit 701 may further include a prompting subunit 7011 and a receiving subunit 7012, where the prompting subunit 7011 is configured to prompt the user to input the SSID and password of the wireless network, and the receiving subunit 7012 is configured to receive the SSID and password of the wireless network that are input by the user.

The WIFI control unit 702 is configured to control switching of a WIFI working mode of the terminal. For example, the WIFI control unit 702 controls the WIFI module of the terminal to switch from a STA working mode to an AP working mode, or switch from an AP working mode to a STA working mode. The WIFI module 703 is further configured to transmit an SSID signal of the terminal when the terminal is in the AP working mode.

The detecting unit 705 is configured to detect a smartcard that accesses the terminal.

The smartcard interacting unit 706 is configured to send the SSID and password of the wireless network to the smartcard that accesses the terminal, and receive a connection result that is of a connection to the wireless network and is returned by the smartcard.

In this embodiment of the present invention, the processing unit 707 is configured to instruct the WIFI control unit 702 to control the terminal to switch to the STA working mode.

The WIFI control unit 702 is further configured to, when the connection result of the connection to the wireless network is a success, control the terminal to switch to the STA working mode.

The WIFI module 703 of the terminal is configured to switch to the STA mode according to an instruction of the WIFI control unit 702, and connect to the wireless network.

The detecting unit 705 is further configured to search for the smartcard that has already accessed the wireless network.

The smartcard interacting unit 706 is further configured to control the smartcard.

The client 70 further includes a displaying unit 707, which is configured to, when the connection result of the connection to the wireless network is a failure, display prompt information of the connection failure and notify a user of the connection failure.

The client further includes a processing unit 708, which is configured to connect to an official website corresponding to the smartcard, query information corresponding to an error code, and acquire a solution according to the information corresponding to the error code, so that a fault of connecting to the wireless network by the smartcard is solved in time, and timeliness of connecting to the wireless network by the smartcard is ensured.

In another embodiment of the present invention, the client 70 further includes a processing unit 708 and a displaying unit 707.

The processing unit 708 is configured to, when the connection result of the connection to the wireless network is a failure, instruct the displaying unit 507 to display prompt information of the connection failure and notify a user of the connection failure.

The displaying unit 707 is configured to display the prompt information of the connection failure.

The processing unit 708 is further configured to connect to an official website of the smartcard and query a solution corresponding to an error code, so that a fault of connecting to the wireless network by the smartcard is solved in time, and timeliness of connecting to the wireless network by the smartcard is ensured.

The client in this embodiment of the present invention may be installed in the terminal, and the terminal may include a mobile terminal and an intelligent terminal, such as a mobile phone, a PAD, and a palmtop computer.

The client provided in this embodiment of the present invention acquires an SSID and a password of a wireless network and notifies the smartcard of the SSID and password of the wireless network, so that the smartcard connects to the wireless network; and in addition, the client can manage the smartcard according to a result of a connection success of the smartcard, so that the management on the smartcard is quicker, more convenient, and more flexible. In addition, in this embodiment of the present invention, the client can further prompt a user about a connection situation according to a connection result that is returned by the smartcard, so as to improve user experience.

FIG. 8 is a schematic structural diagram of a smartcard for accessing a wireless network according to an embodiment of the present invention, where the smartcard is configured to interact with a terminal and access the wireless network, and a smartcard client corresponding to the smartcard is installed on the terminal. The smartcard includes a WIFI module 801, an accessing unit 802, and a client interacting unit 803.

The WIFI module 801 is configured to search for an SSID signal of the terminal.

The accessing unit 802 is configured to access, according to the SSID signal of the terminal, a network provided by the terminal, and is further configured to access the wireless network according to an SSID and a password of the wireless network that are received by the client interacting unit 803.

The client interacting unit 803 is configured to receive the SSID and password of the wireless network that are sent by the smartcard client, and is further configured to return a connection result of a connection to the wireless network to the smartcard client.

In this embodiment of the present invention, the smartcard connects to the wireless network, where if the connection succeeds, a connection result that includes a success code is returned to the smartcard client; and if the connection fails, a connection result that includes an error code may be returned to the smartcard client.

The smartcard in this embodiment of the present invention is disposed in a wearable device.

The smartcard provided in this embodiment of the present invention acquires an SSID and a password of a wireless network and connects to the wireless network; and in addition, the smartcard can return a result of a connection success of the smartcard to a smartcard client, so that the smartcard client can flexibly and quickly manage the smartcard, and the management on the smartcard is quicker, more convenient, and more flexible. In addition, in this embodiment of the present invention, the smartcard can further prompt a user about a connection situation according to a connection result that is returned by the smartcard, so as to improve user experience.

An embodiment of the present invention further provides a terminal for accessing a wireless network. As shown in FIG. 9, the terminal includes a processor 901, a WIFI module 902, a user interacting interface 903, and a smartcard interacting interface 904. The processor 901, the WIFI module 902, the user interacting interface 903, and smartcard interacting interface 904 are connected by using a bus.

The processor 901 is configured to acquire an SSID and a password of the wireless network.

In this embodiment of the present invention, the processor 901 may acquire the SSID and password of the wireless network in multiple manners.

For example, if the terminal currently accesses a wireless network, the processor 901 may acquire an SSID and a password of the wireless network that is currently accessed by the terminal. The processor 901 may further acquire the SSID and password of the wireless network by instructing the user interacting interface 903 to prompt a user to input the SSID and password of the wireless network.

The processor 901 is further configured to control switching of a working mode of the WIFI module 902. For example, the working mode is switched from a STA working mode to an AP working mode, or switched from an AP working mode to a STA working mode.

The WIFI module 902 is configured to transmit an SSID signal in the AP working mode.

The WIFI module 902 is further configured to connect to the wireless network in the STA mode.

The processor 901 is further configured to detect a smartcard that accesses the terminal.

The processor 901 is further configured to control the smartcard interacting interface 904 to send the SSID and password of the wireless network to the smartcard that accesses the terminal.

The smartcard interacting interface 904 is configured to send the SSID and password of the wireless network to the smartcard that accesses the terminal, and receive a connection result that is of the connection to the wireless network and is returned by the smartcard.

In this embodiment of the present invention, the processor 901 is further configured to, when the connection result of the connection to the wireless network is a success, instruct the WIFI module 902 to switch to the STA working mode.

The WIFI module is configured to connect to the wireless network.

The processor 901 is further configured to control the smartcard interacting interface 904 to search for the smartcard that has already accessed the wireless network, the smartcard interacting interface 904 searches for the smartcard that has already accessed the wireless network, and the processor 901 is further configured to manage the smartcard.

The processor 901 is further configured to, when the connection result of the connection to the wireless network is a failure, instruct the user interacting interface 903 to display prompt information of the connection failure, and notify a user of the connection failure.

The processor 901 is further configured to connect to an official website of the smartcard and query a solution corresponding to an error code, so that a fault of connecting to the wireless network by the smartcard is solved in time, and timeliness of connecting to the wireless network by the smartcard is ensured.

The terminal provided in this embodiment of the present invention acquires an SSID and a password of a wireless network and notifies the smartcard of the SSID and password of the wireless network, so that the smartcard connects to the wireless network; and in addition, the terminal can manage the smartcard according to a result of a connection success of the smartcard, so that the management on the smartcard is quicker, more convenient, and more flexible. In addition, in this embodiment of the present invention, the terminal can further prompt a user about a connection situation according to a connection result that is returned by the smartcard, so as to improve user experience.

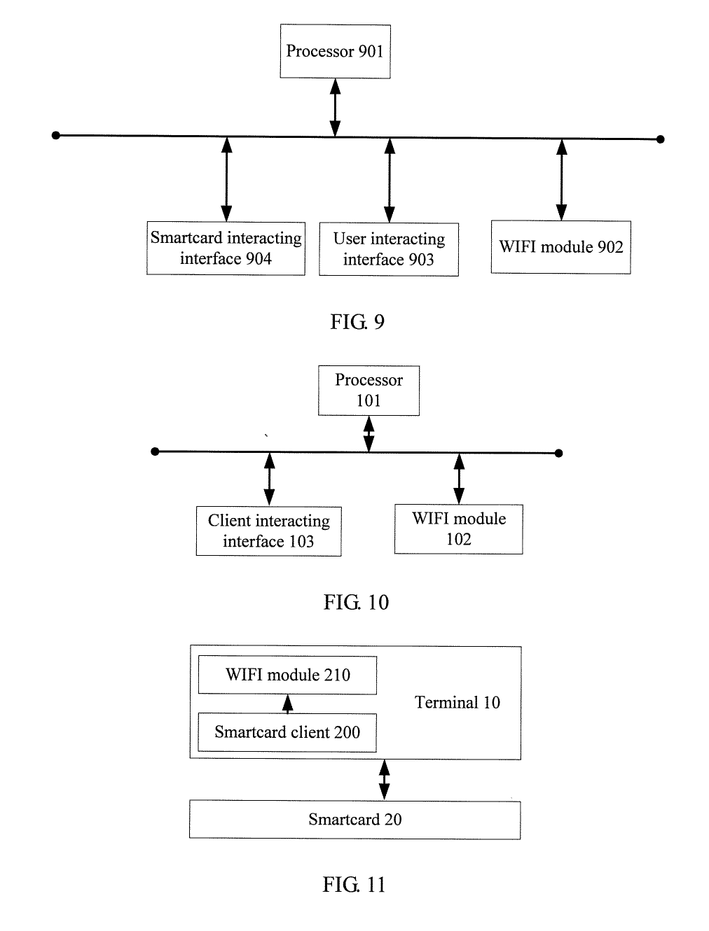

An embodiment of the present invention further provides a smartcard for accessing a wireless network. As shown in FIG. 10, the smartcard includes a processor 101, a WIFI module 102, and a client interacting interface 103. The processor 101, the WIFI module 102, and the client interacting interface 103 are connected by using a bus. The smartcard can interact with a terminal on which the smartcard client has been installed.

The WIFI module 102 is configured to search for an SSID signal of the terminal.

The WIFI module 102 is further configured to access, according to the SSID signal of the terminal, a network provided by the terminal.

The client interacting interface 103 is configured to receive an SSID and a password of the wireless network that are sent by the smartcard client.

The WIFI module 102 is further configured to access the wireless network according to the SSID and password of the wireless network.

The client interacting interface 103 is further configured to return a connection result of a connection to the wireless network to the smartcard client.

In this embodiment of the present invention, the smartcard connects to the wireless network, where if the connection succeeds, a connection result that includes a success code is returned to the smartcard client; and if the connection fails, a connection result that includes an error code may be returned to the smartcard client.

The smartcard in this embodiment of the present invention is disposed in a wearable device.

The smartcard provided in this embodiment of the present invention acquires an SSID and a password of a wireless network and connects to the wireless network; and in addition, the smartcard can return a result of a connection success of the smartcard to a smartcard client, so that the smartcard client can flexibly and quickly manage the smartcard, and the management on the smartcard is quicker, more convenient, and more flexible. In addition, in this embodiment of the present invention, the smartcard can further prompt a user about a connection situation according to a connection result that is returned by the smartcard, so as to improve user experience.

A system for accessing a wireless network according to an embodiment of the present invention is described with reference to FIG. 1. As shown in FIG. 1, the system includes a smartcard 20, a terminal 10, and a wireless network 30. In this embodiment of the present invention, the smartcard client is installed in the terminal.

The terminal is configured to acquire an SSID and a password of the wireless network, and transmit an SSID signal of the terminal. The smartcard searches for the SSID signal of the terminal and accesses the terminal; the terminal sends the SSID and password of the wireless network to the smartcard; the smartcard accesses the wireless network according to the received SSID and password of the wireless network, and returns a connection result of the access to the wireless network to the terminal. When the connection result of the access to the wireless network is a success, the terminal switches to a STA working mode, accesses the wireless network, and searches for the smartcard that has already accessed the wireless network; and the terminal may perform management on the smartcard by using the smartcard client. When the connection result of the access to the wireless network is a failure, the terminal displays prompt information of the connection failure, and notifies a user of the connection failure. The terminal may further connect to an official website corresponding to the smartcard and query a solution corresponding to an error code, so that a fault of connecting to the wireless network by the smartcard is solved in time, and timeliness of connecting to the wireless network by the smartcard is ensured.

The terminal provided in this embodiment of the present invention acquires an SSID and a password of a wireless network′ and notifies the smartcard of the SSID and password of the wireless network, so that the smartcard connects to the wireless network; and in addition, the terminal can manage the smartcard according to a result of a connection success of the smartcard, so that the management on the smartcard is quicker, more convenient, and more flexible. In addition, in this embodiment of the present invention, the terminal can further prompt a user about a connection situation according to a connection result that is returned by the smartcard, so as to improve user experience.

As shown in FIG. 11, which is a system for accessing a wireless network according to an embodiment of the present invention. The system includes a terminal 10 and a smartcard 20, where a smartcard client 200 corresponding to the smartcard is installed on the terminal. The smartcard client is configured to acquire an SSID and a password of the wireless network, control a WIFI working mode of the terminal to be an AP mode, and detect the smartcard that accesses the terminal. The terminal is configured to transmit an SSID signal of the terminal in the AP working mode. The smartcard is configured to search for the SSID signal of the terminal and access the terminal, and is further configured to connect to the wireless network according to the received SSID and password of the wireless network that are sent by the smartcard client, and return a connection result to the smartcard client.

The smartcard client is further configured to receive the connection result that is returned by the smartcard, and if the result is a connection success, the terminal is controlled, according to the received result of the connection success, to switch to a STA working mode; the terminal is further configured to connect to the wireless network in the STA working mode; and the smartcard client is further configured to search for the smartcard that has already accessed the wireless network so as to perform control on the smartcard.

In this embodiment of the present invention, as shown in FIG. 11, the smartcard client 200 can implement, by controlling a WIFI module 210 in the terminal, switching of the WIFI working mode between the STA working mode and the AP working mode.

The smartcard client is further configured to receive a connection result that includes an error code and is returned by the smartcard, connect to an official website of the smartcard through a network, query information corresponding to the error code, and acquire a solution corresponding to the error code, so that a fault of connecting to the wireless network by the smartcard is solved in time, and timeliness of connecting to the wireless network by the smartcard is ensured.

The system provided in this embodiment of the present invention acquires an SSID and a password of a wireless network and notifies the smartcard of the SSID and password of the wireless network, so that the smartcard connects to the wireless network; and in addition, the system can manage the smartcard according to a result of a connection success of the smartcard, so that the management on the smartcard is quicker, more convenient, and more flexible. In addition, in this embodiment of the present invention, the system can further prompt a user about a connection situation according to a connection result that is returned by the smartcard, so as to improve user experience.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a fault of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

1. A method for accessing a wireless network, the method comprising:
acquiring, by a terminal, an SSID (Service Set Identifier) and a password of the wireless network;
controlling a WIFI (Wireless Fidelity) working mode of the terminal to be an AP (Access Point) mode, and transmitting an SSID signal of the terminal; and
detecting a smartcard that accesses the terminal, and sending the SSID and password of the wireless network to the smartcard, so that the smartcard connects to the wireless network according to the received SSID and password of the wireless network and returns a connection result to the terminal.

2. The method according to claim 1, wherein that the smartcard connects to the wireless network according to the received SSID and password of the wireless network and returns a connection result to the terminal comprises:
connecting, by the smartcard, to the wireless network; and if the connection succeeds, returning a connection result that comprises a success code to the terminal.

3. The method according to claim 2, further comprising:
if the connection result that is returned by the smartcard and received by the terminal indicates a connection success, controlling, according to the received result of the connection success, the terminal to switch to a STA (Station) working mode, enabling the terminal to connect to the wireless network and search for the smartcard that has already accessed the wireless network so as to perform control on the smartcard.

4. The method according to claim 1, wherein that the smartcard connects to the wireless network according to the received SSID and password of the wireless network and returns a connection result to the terminal comprises:
if the connection fails, returning a connection result that comprises an error code to the terminal, enabling the terminal manages the smartcard according to the connection result that is returned by the smartcard.

5. The method according to claim 1, wherein a smartcard client corresponding to the smartcard is installed on the terminal to implement the method.

6. A method for accessing a wireless network, the method comprising:
controlling a WIFI (Wireless Fidelity) working mode of a terminal to be an AP (Access Point) mode, and transmitting an SSID (Service Set Identifier) signal of the terminal, so that a smartcard searches for the SSID signal of the terminal and accesses the terminal; and
detecting the smartcard that accesses the terminal, prompting a user to input an SSID and a password of a wireless network, and sending the SSID and password of the wireless network to the smartcard, wherein the smartcard connects to the wireless network according to the received SSID and password of the wireless network, and returns a connection result to the smartcard client.

7. The method according to claim 6, further comprising:
if the connection result that is returned by the smartcard and received by the terminal is a connection success, controlling, according to the received result of the connection success, the terminal to switch to a STA (Station) working mode, enabling the terminal to connect to the wireless network and search for the smartcard that has already accessed the wireless network so as to perform control on the smartcard.

8. The method according to claim 6, further comprising:
if a connection result that comprises an error code and is returned by the smartcard and received by the terminal is a connection failure, connecting to an official website of the smartcard through a network, and querying information corresponding to the error code.

9. The method according to claim 8, wherein the terminal implements the method by installing a smartcard client corresponding to the smartcard.

10-17. (canceled)

18. A system for accessing a wireless network, wherein the system comprises a terminal and a smartcard, and a smartcard client corresponding to the smartcard is installed on the terminal, wherein
the smartcard client is configured to acquire an SSID (Service Set Identifier) and a password of the wireless network, control a WIFI (Wireless Fidelity) working mode of the terminal to be an AP (Access Point) mode, and detect the smartcard that accesses the terminal;
the terminal is configured to transmit an SSID signal of the terminal in the AP working mode; and
the smartcard is configured to search for the SSID signal of the terminal and access the terminal, and is further configured to connect to the wireless network according to the received SSID and password of the wireless network that are sent by the smartcard client, and return a connection result to the smartcard client.

19. The system according to claim 18, wherein the smartcard client is further configured to receive the connection result that is returned by the smartcard, and if the result is a connection success, control, according to the received result of the connection success, the terminal to switch to a STA (Station) working mode;
the terminal is further configured to connect to the wireless network in the STA working mode; and
the smartcard client is further configured to search for the smartcard that has already accessed the wireless network so as to perform control on the smartcard.

20. The system according to claim 18, wherein the smartcard client is further configured to receive a connection result that comprises an error code and is returned by the smartcard, connect to an official website of the smartcard through a network, and query information corresponding to the error code.

21-22. (canceled)

23. A terminal, comprising:
a processor, a Wireless Fidelity (WIFI) module, a user interacting interface, and a smartcard interacting interface, wherein the processor, the WIFI module, the user interacting interface and the smartcard interacting interface are connected by using a bus;
wherein the processor is configured to acquire an Service Set Identifier (SSID) and a password of the wireless network, and control a WIFI working mode of the terminal to be an Access Point (AP) mode, and transmitting an SSID signal of the terminal;
wherein the WIFI module is configured to transmit an SSID signal in the AP working mode, and connect to the wireless network in a Station (STA) mode;
wherein the processor is configured to detect a smartcard that accesses the terminal, and control the smartcard interacting interface to send the SSID and password of the wireless network to the smartcard that accesses the terminal, enabling the smartcard to connect to the wireless network according to the received SSID and password of the wireless network and return a connection result to the terminal; and
wherein the smartcard interacting interface is configured to send the SSID and password of the wireless network to the smartcard that accesses the terminal, and receive a connection result that is of the connection to the wireless network and is returned by the smartcard.

24. The terminal according to claim 23, wherein:
the processor is further configured to, when the connection result of the connection to the wireless network is a success, instruct the WIFI module to switch to the STA working mode;
the WIFI module configured to connect to the wireless network;
the processor further configured to control the smartcard interacting interface to search for the smartcard that has already accessed the wireless network;
the smartcard interacting interface configured to search for the smartcard that has already accessed the wireless network; and
the processor further configured to manage the smartcard.

25. The terminal according to claim 23, wherein the processor is further configured to, when the connection result of the connection to the wireless network is a failure, instruct the user interacting interface to display prompt information of the connection failure, and notify a user of the connection failure, connect to an official website of the smartcard and query a solution corresponding to an error code.

26. A smartcard, comprising:
a Wireless Fidelity (WIFI) module, and a client interacting interface, wherein the WIFI module and the client interacting interface are connected by using a bus, and the smartcard interacts with a terminal on which the smartcard client has been installed;
wherein the WIFI module is configured to search for a Service Set Identifier (SSID) signal of the terminal, and access a network provided by the terminal according to the SSID signal of the terminal;
wherein the client interacting interface configured to receive an SSID and a password of the wireless network that are sent by the smartcard client; and
wherein the WIFI module further configured to access the wireless network according to the SSID and password of the wireless network.
